(19) United States
(12) Patent Application Publication
(10) Pub. No.: US 2009/0284478 A1
(43) Pub. Date: Nov. 19, 2009

(54) Multi-Contact and Single-Contact Input

(75) Inventors: Pamela De la Torre Baltierra, Carnation, WA (US); Scott Sheehan, Seattle, WA (US); Xiao Tu, Sammamish, WA (US); Bryan D. Scott, Mill Creek, WA (US); Reed L. Townsend, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/120,820

(22) Filed: May 15, 2008

(51) Int. Cl. G06F 3/041

(52) U.S. Cl. 345/173

(57) ABSTRACT

This document describes tools capable of initiating a function based on one or more tactile contacts received through a contact detection device, such as a touch pad. In some embodiments, the tools identify tactile contacts in accordance with the tool's input mode. The tools may use the input mode to determine what gestures may be identified for the tactile contacts. In some embodiments, these tools switch input modes based on a number or characteristic of tactile contacts electronically represented in contact data. By so doing, the tools may more accurately determine appropriate gestures or provide a broader range of functions based on tactile contacts received through a contact detection device.

### BACKGROUND

People interact with computing systems through input devices, such as keyboards, mice, touch pads, and the like. These input devices are important because if users cannot easily or robustly interact with a computing system because of its input device, users may reject the computing system. For example, if a cellular phone has a clunky, irritating number pad, the cellular phone may fail in the market. Similarly, if a laptop computer has a touch pad that does not understand enough functions or requires awkward gestures, the laptop may also be rejected in the market.

More and more, computing systems are sold with touch pad or touch screen input devices. These touch devices accept user input based on physical contact with one or more detectors in the touch device. Current touch devices, however, are not well suited to many computing tasks and applications because they often cannot differentiate between enough different types of physical contacts or require users to perform awkward gestures.

### SUMMARY

This document describes tools capable of initiating a function based on one or more tactile contacts received through a contact detection device, such as a touch pad. In some embodiments, the tools identify tactile contacts in accordance with the tool's input mode. The tools may use the input mode to determine what gestures may be identified for the tactile contacts. In some embodiments, these tools switch input modes based on a number or characteristic of tactile contacts electronically represented in contact data. By so doing, the tools may more accurately determine appropriate gestures or provide a broader range of functions based on tactile contacts received through a contact detection device.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions (e.g., one or more computer-readable media having executable instructions), components, and/or technique(s) as permitted by the context above and throughout this document.

### BRIEF DESCRIPTION OF THE DRAWINGS

The detailed description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 is an illustration of an example environment having a computer system and contact detection device.

FIG. 2 is a flow diagram depicting a procedure in an example implementation by which the tools may act to switch input modes based on a state change in tactile contacts.

FIG. 3 is a flow diagram depicting a procedure in an example implementation by which the tools may act to initiate a function in accordance with the tools' sub-mode based on movement of a contact input.

FIG. 4 is a flow diagram depicting a procedure in an example implementation by which the tools may act to initiate a feedback function.

### DETAILED DESCRIPTION

Overview

More and more, computing systems are sold with contact input devices, such as a touch pad or a touch screen. These devices accept user input based on physical contact, such as tactile contact for one or more stylus or finger contacts, with one or more contact detectors included in the touch pad. Current touch pads, however, are not well suited to many computing tasks and applications because they often cannot differentiate between enough different types of physical contacts or require users to perform awkward gestures.

This document describes an identifier module included with a contact detection device to identify or recognize an electronic version of one or more tactile contacts represented in contact data obtained from contact detectors in the contact detection device. One or more contact state machines and a monitoring state machine are included with the identifier module to switch the identifier module's input mode, which controls which gestures that the identifier module can identify. The contact state machines and/or monitoring state machine may receive and watch the contact data for a change in a number of tactile contacts and characteristics of the tactile contacts represented in the contact data. In response to a change represented in contact data, each contact state machine may determine to change state. The monitoring state machine monitors the state of the contact state machine to determine when the contact state machine changes state. The monitoring state machine changes the identifier module's input mode in response to the contact state machine changing state.

In at least this way, the monitoring state machine determines what gestures the identifier module may identify. If a person contacts the contact detection device with two fingertips, the identifier module may identify which gesture is appropriate or intended by a user that made the tactile contacts to the contact detection device based on the input mode. Thus, when identifying gestures, the identifier module may analyze individual tactile contacts based on the identifier module's input mode or sub-mode. By treating individual tactile contacts differently based on the input mode or sub-mode, the identifier module can distinguish combinations of tactile contacts. This feature permits the identifier module to identify gestures from multiple tactile contacts without interfering with the identifier module's ability to identify gestures from a single tactile contact.

An environment in which the tools may enable these and other actions is set forth below in a section entitled “Example Operating Environment.” This is followed by another section describing “Example Techniques.” This overview, including these section titles and summaries, is provided for the reader's convenience and is not intended to limit the scope of the claims or the entitled sections.

Example Operating Environment

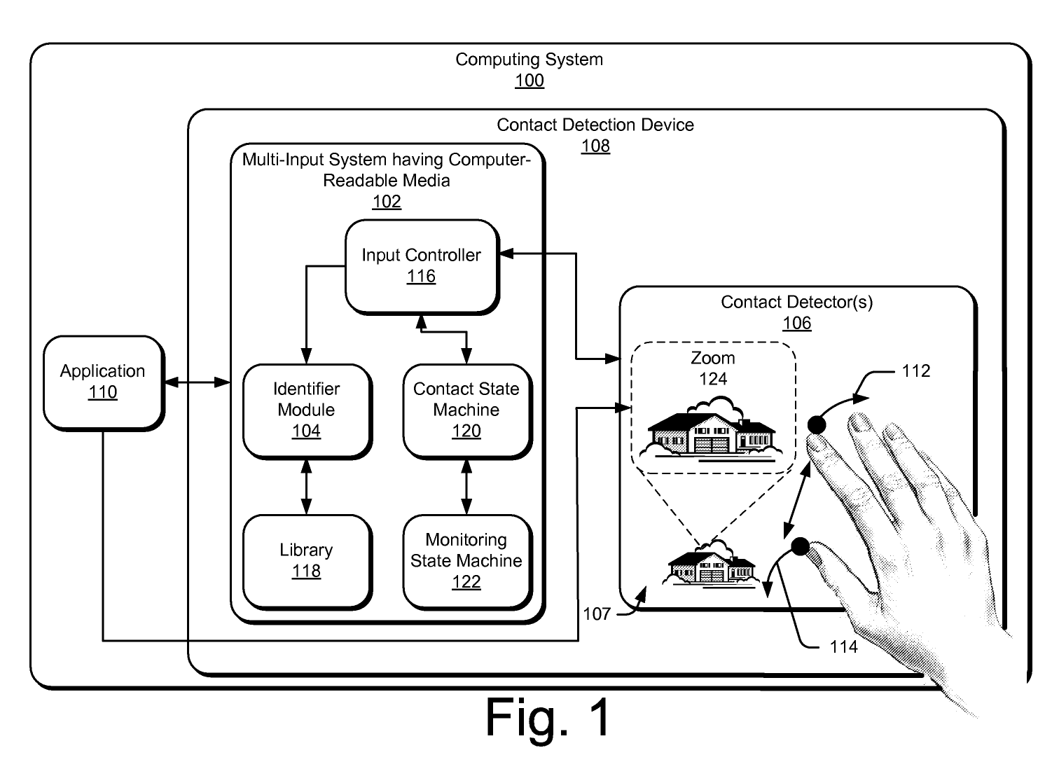

FIG. 1 references a computing system 100 with a multi-input system 102 including an identifier module 104 that identifies gestures input by a user and detected by one or more contact detectors 106 (shown integrated with a display 107) included in a contact detection device 108. Upon identifying the gestures, the identifier module 104 initiates an application 110 to provide the function (e.g., zooming) that is mapped to the gestures. Functions include inputting data, manipulating data, changing a display (e.g., pan, zoom, and rotate), providing audio, and the like.

Various systems and devices may benefit from the multi-input system 102, such as media players, remote controls, smart phones, personal digital assistants, personal audio devices, global positioning systems, Internet appliances, wireless connectivity devices, vehicle control systems, vehicle entertainment systems, tablet computers, laptop computers, standalone input and/or output devices, and the like. Note that the multi-input system 102 may be separate from or integral with the contact detection device 108 and that a display and the contact detection device 108 may be separate or combined. Note also that the multi-input system 102 comprises or has access to computer-readable media on which various applications, software, or other executable instructions may be stored.

In some embodiments, the multi-input system 102 is operating system (OS) specific. When the multi-input system is OS specific, the multi-input system 102 provides functions that are specific to the OS and various applications (e.g., the application 110) configured for use with the OS. In other embodiments, the multi-input system 102 is configured for a specific application. The OS or a module within the OS may act as an intermediary between the multi-input system 102 and the application 110.

In the example environment of FIG. 1, the multi-input system 102 is included in the contact detection device 108. As illustrated, the contact detectors 106 are included in the contact detection device 108 and are integrated with the display 107 (e.g., a liquid crystal display screen). The individual contact detectors may be configured to detect multiple physical, tactile contacts, such as a first tactile contact 112 and a second tactile contact 114. Multiple individual contact detectors may identify a tactile contact (e.g., a first contact detector detects a first tactile contact while a second contact detector detects a second tactile contact). The contact detectors 106 may be aligned with the pixels in a column/row configuration or otherwise.

The contact detectors 106 may be configured to detect an x-y position, i.e., a two-dimensional position, of the tactile contact. The contact detectors may also detect, for example, duration of contact (whether static or moving), contact pressure, contact height, contact width, bounding box for multiple contacts, rate of positional change, angular orientation, contact vectors, movement of the contact, and other information set forth herein.

In some embodiments, an input controller 116 is included in the multi-input system 102 to convert the contact detector output (e.g., the electrical signals from the contact detectors) into contact data. For instance, the input controller 116 includes appropriate hardware/software for converting the contact detector output into contact data that is usable by the multi-input system 102. In other embodiments, the input controller 116 can be included in the multi-input system 102, contained in a separate module, or performed by a general purpose processor loaded with firmware or software for converting contact detector output into contact data.

The identifier module 104 may heuristically identify or recognize gestures from the contact data, such as for text recognition. Thus, if a user previously arched his/her lines, the identifier module 104 heuristically interprets the contact data when identifying gestures to identify the straight line. If the gestures are mapped to a function, the identifier module 104 initiates the mapped function upon identifying the gestures.

For example, the identifier module 104 may combine contact data that indicates physical contact with contact detectors included in the contact detection device at x-y positions to identify a straight line. If a straight line is mapped to a function, the identifier module 104 initiates the function. In response, the application 110 provides the initiated function.

The identifier module 104 may also identify gestures from contact data within a pre-defined range rather than heuristically identifying the gestures. As a result, the identifier module 104 identifies gestures that are within tolerance but does not use heuristic techniques. The identifier module's range or tolerance can be selected to avoid or minimize misidentification.

The identifier module 104 may also or instead use a library 118 storing a lookup table to identify the gestures from the contact data. For example, the identifier module 104 may identify the gestures by comparing contact data with sample contact data or parameters included in the lookup table to initiate the mapped function.

Exemplary physical gestures and mapped functions include, but are not limited to:

TABLE 1
Exemplary Gestures/Mapped Function

| | | Mapped |
|---|---|---|
| Tactile Contacts - Contact Data Represents | Gesture | Function |
| First and second tactile contacts that both | Pinch | Zoom Out |
| move and converge along a common axis | | |
| First tactile contact stationary and second | Modified | Zoom Out |
| tactile contact moves toward first tactile | Pinch | |
| contact | | |
| First and second tactile contacts that both | Spread | Zoom In |
| move and diverge along a common axis | | |
| First tactile contact stationary and second | Modified | Zoom In |
| tactile contact moves away from first tactile | Spread | |
| contact | | |
| Both first and second tactile contacts move | Double | Pan |
| perpendicularly to an axis extending through | Slide | |
| the initial contact points of the first and | | |
| second tactile contacts | | |
| Two momentary and stationary tactile | Two-Finger | Double Click |
| contacts | tap | |
| First tactile contact detected and | Sequential | Right Click |
| sequentially a second tactile contact is | Tap | |
| detected, neither tactile contact is moving | | |
| Two tactile contacts dwell and are | Two-Finger | Route Find |
| positioned with respect to a map | Press-and- | (map |
| | Hold | directions) |
| Two tactile contacts are side-by-side, both | Diagonal | Flip 3D - |
| move diagonally | Double | view re- |
| | Slide | arrangement |
| Two tactile contacts rotating around a center | Two-Finger | Rotate View |
| point | Rotate | |
| Four momentary and stationary tactile | Four-Finger | Launch |
| contacts | Tap | Application |

The multi-input system 102 switches or controls the identifier module's input mode based on the number of tactile contacts represented in the contact data and/or other information, such as characteristics of the tactile contacts. By switching identifier module input modes, the multi-input system 102 determines what gestures can be identified and thus what functions can be initiated. Additionally, by switching input modes, the identifier module may initiate a large number of functions in comparison to the number of tactile contacts associated with the functions, misidentification can be avoided, and basic tactile contacts can be reused.

For example, when the identifier module 104 is in single-input mode, the identifier module 104 is prohibited from identifying more than one tactile contact. In this manner, inadvertent physical contact with the contact detectors 106 does not initiate a function.

In some cases, such as when multiple tactile contacts are represented in the contact data, the identifier module's input mode is based on the number of tactile contacts present in the contact data. Thus, the identifier module identifies three tactile contacts when the identifier module's input mode is set to identify three tactile contacts.

One or more contact state machines 120 and a monitoring state machine 122 may be included in the multi-input system 102 to switch or determine the identifier module's input mode. The contact state machines 120 (e.g., multiple instances of the contact state machine, one for each tactile contact) may watch the input controller 116 for contact data that indicates a change in the number of tactile contacts (e.g., the addition of a tactile contact or removal of a tactile contact) represented in the contact data. Each contact state machine 120 may change state in response to its tactile contact changing state (as represented in the contact data).

In some embodiments, each tactile contact has its own instance of a contact state machine. Thus, a first finger may have a first contact state machine and a second finger a second contact state machine. In these cases, the monitoring statement machine 122 monitors the state of the contact state machines 120 to determine when each contact state machine 120 changes state. Each of the contact state machines 120 may change state when the particular tactile contact changes state.

Thus, the monitoring state machine 122 monitors the change in the number of tactile contacts by monitoring the state of the contact state machines 120. Upon determining that the contact state machines 120 has changed state and the change in the number of tactile contacts, the monitoring state machine 122 switches the identifier module's input mode from a previous input mode to a current input mode.

For example, when a user makes a pinching gesture, a user may contact the contact detection device 108 with his/her thumb before contacting the contact detection device 108 with his/her forefinger. In this scenario, the contact state machine 120 for the thumb changes state when the user originally contacts the contact detection device 108 with his/her thumb. The contact state machine 120 for the forefinger may change state when the user presses his/her forefinger against the contact detection device 108. In response to these state changes and the number of contacts change, the monitoring state machine 122 changes the identifier module's input mode.

Note also that the contact state machines 120 may differ, in some embodiments. For example, a first contact state machine for a first or primary tactile contact (e.g., a forefinger) may be backward compatible with single-finger input modes and scenarios, such as touch widget, flicks, and double-tap support. Other state machines may also have this compatibility or they may not. Further, contact state machines for non-first or non-primary tactile contacts may have additional or different logic, such as logic that relates to a second contact but that would not pertain to a first or primary contact (e.g., for gestures where a second finger's actions are determinative for a gesture but do not pertain to a first finger's actions). This logic may also be included in a contact state machine for a first or primary tactile contact, though such logic may not be used in many situations.

The monitoring state machine 122 may also switch the identifier module's input mode at a discrete time or on the occurrence of an additional event, such as when the contact detection device 108 detects a static tactile contact.

In another example, the identifier module's input mode is set at a previous point-in-time or upon the occurrence of another event (e.g., one finger is stationary). In this way, the identifier module 104 may remain in single tactile contact mode because the input mode was set at a previous point-in-time even though a user accidently contacts the contact detection device 108 with another finger. The identifier module 104 may also identify two tactile contacts even though the user is currently touching the contact detection device 108 with three fingers because the identifier module's input mode was set to identify two tactile contacts at a previous point-in-time.

The identifier module may also receive a user's selection (e.g., a mouse click) and, responsive to receiving the selection, refrain from entering another input mode.

Turning again to the multi-input system 102, the system may include additional contact and monitoring state machines. For example, additional combinations of contact and monitoring state machines may be included for watching additional tactile contacts represented in the contact data. In these embodiments, the number of contact state machines and monitoring state machines in the multi-input system 102 corresponds to the number of tactile contacts that the contact detection device 108 can detect.

The contact and monitoring state machines may be configured to switch or determine a sub-mode for the identifier module 104. For example, when the identifier module 104 is in multi-input mode, the monitoring state machine 122 may switch the identifier module 104 between sub-modes depending on a characteristic of the tactile contact (e.g., movement) as represented in the contact data.

The contact state machine 120 (or instances of it) may change its state when one or more of the tactile contacts start moving. The monitoring state machine 122 switches the sub-mode of the identifier module 104 in response to the contact state machine 120 changing state. For instance, the monitoring state machine 122 switches the identifier module 104 from a multi-input static sub-mode to a multi-input hybrid sub-mode when one of the tactile contacts moves while the other tactile contact remains fixed. In this case, the contact state machine 120 for the second tactile contact changes state in response to the second tactile contact beginning to move. The monitoring state machine 122, monitoring the state of the contact state machine 120, switches the identifier module 104 to the hybrid sub-mode.

For reference, Table 2 below lists sample input modes and sub-modes with corresponding tactile contacts. Additional input modes may be included based on the capabilities of the contact detectors 106.

TABLE 2
Example Tactile Contacts and Input Modes and Sub-Modes

| Input Modes/Sub-Modes | Corresponding Tactile contact |
|---|---|
| Zero Mode | No Tactile Contact Detected |
| Single-Input Mode | Single Tactile Contact Detected |
| Press and Hold Sub-Mode | Current Tactile Contact Stationary |
| Moving Sub-Mode | Current Tactile Contact Moving |
| Multi-Input Mode | Multiple Tactile Contacts Detected |
| Moving Sub-Mode | Current Tactile Contacts-Moving |
| Static Sub-Mode | Current Inputs Stationary |
| Hybrid Sub-Mode | At Least One Input is Moving and at |
| | Least One Input is Stationary |

By changing input modes and sub-modes, the identifier module 104 can treat an individual tactile contact as a subset of the group when identifying tactile contacts. In addition, by configuring the identifier module in this manner, the multi-input system 102 can identify multiple tactile contacts represented in the contact data without impacting single tactile contact identification. In other words, by configuring the identifier module 104 to identify tactile contacts with respect to a group (based on the identifier module's input mode), misidentification may be minimized or avoided and the multi-input system may be backward compatible with applications that are not multi-input enabled. In this way, the identifier module's input mode determines what number of tactile contacts can be identified within the group. Further, by configuring the identifier module in this manner, basic tactile contacts, such a tap or a straight line, may be reused between input modes.

These are not exhaustive. By way of example, the identifier module may initiate an initial function and continue that initial or subsequent function until interrupted by another function that stops the initial function. For example, the application 110 may continue to pan with inertia after a pan gesture until a user triggers a stop function. In another example, the identifier module 104 causes the rate of the function to increase the longer the function is active (e.g., without being stopped). A user may stop the initial function by triggering a stop function. In another example, the multi-input system 102 determines the extent of the initiated function based on a characteristic of the tactile contact—when the contact data indicates that the tactile contact was quick, based on a predefined standard, the mapped function is performed in a rapid manner, also based on a predefined standard. Further still, the identifier module 104 may initiate an ancillary function in addition to a primary function. For example, while the identifier module 104 initiates a zoom function 124, the identifier module may additionally initiate a toolbar, an icon, or some other interactive graphical object that is associated with the primary function.

The tools may perform other functions and actions as well. For example, a user may inadvertently provide or attempt to provide a tactile contact that exceeds the capacity of the application 110. In response, the identifier module 104 may initiate a feedback function to alert a user to a condition or situation. If, for example, a user attempts to pan beyond the end of a web page, the identifier module 104 initiates a feedback function that alerts the user to the condition. In this instance, the application 110 signals the multi-input system 102 that the initiated function exceeds the application's capacity. In response, the identifier module 104 initiates a feedback function so that the user is alerted to the situation. Exemplary feedback functions include, but are not limited to, jittering and distorting a display (e.g., appearing to stretch a document's text), a shaking zoom (zooming in and out rapidly to show that the limit of the zoom is reached), a shaking pan (panning in opposite directions rapidly to show that the limit of the pan is reached), and a window or frame alteration (e.g., a window around a zoomed or panned display shaking, moving, or stretching when the limit of the zoom or pan is reached). By way of example, consider a feedback function where the window or frame around a displayed map is panned beyond the limit of the application. In this case, when a user pans too far (either continuously or with inertia), the application shows the farthest reachable edge of the map and then, with the feedback function, moves the frame or window on the computer screen in the direction of the pan. The moved frame or window may stay moved or snap back to its prior position, as if the frame or window was attached to its prior position on the screen with rubber bands or springs.

Generally, any of the functions described herein can be implemented using software, firmware, hardware (e.g., fixed-logic circuitry), manual processing, or a combination of these implementations. The terms “tool” or “tools” and “module” or “modules” as used herein generally represent software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the tools and modules are platform-independent, meaning that they may be implemented on a variety of commercial computing platforms having a variety of processors.

Example Techniques

The following discussion describes various techniques and procedures, which may be implemented in hardware, firmware, software, or a combination thereof. The procedures are shown as a set of blocks that specify operations performed by one or more entities, devices, modules, and/or the tools (e.g., identifier module 104 of FIG. 1) and are not necessarily limited to the orders shown for performing the operations by the respective blocks. A variety of other examples and sub-techniques are also contemplated.

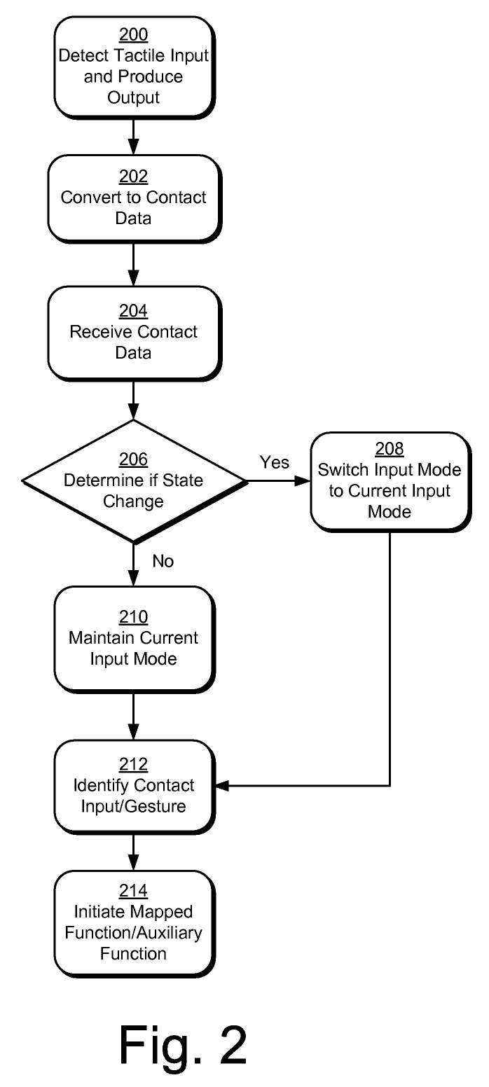

FIG. 2 depicts a procedure in an example implementation in which the tools switch between input modes based on contact data.

Block 200 detects tactile contacts from an object (e.g., a user's finger or stylus) contacting a contact detection device and generates output that represents the detected tactile contact(s). Thus, the tools generate an output that represents the user's physical interaction (e.g., tactile contact) with a tactile contact device (e.g., a touch pad). In one embodiment, the tools detect input from a user touching his/her finger to one or more contact detectors included in the contact detection device. In some embodiments, the tools detect concurrent tactile contacts.

Block 202 converts the tactile contacts to contact data based on the output from block 200. Contact data comprises information about the tactile contacts, such as a location of the tactile contacts, duration of the tactile contacts, movement of the tactile contacts, the force of the tactile contacts, and the like. The tools may concurrently convert output based on multiple tactile contacts into contact data. In some embodiments, the tools convert multiple tactile contacts into contact data as it arrives or by sampling contact detectors.

Block 204 receives the contact data. Block 206 determines if there is a change of state in the tactile contact based on the received contact data. A change in state may occur when a number of tactile contacts represented in the contact data changes. In some embodiments, the tools receive contact data periodically and/or determine if there is a change in state periodically. In others the tools receive and determine state changes constantly. As noted previously, contact data provides information about the tactile contacts sufficient for the tools to determine if a change in state has occurred.

For example, if the contact data indicates that one finger is contacting a contact detection device and then later that two fingers are contacting the contact detection device, the tools may determine that a change in state from one tactile input to two tactile inputs has occurred. This contact data may not be dispositive, however. A single finger may be creating tactile contact and then two fingers (or other part of a hand) may then be in tactile contact with a contact detection device. But the tools may determine that a change in state is not intended or appropriate based on other factors. Thus, other information in the contact data may be used, such as actions of the first finger before the second finger makes tactile contact, or actions of the two fingers before one of them ceases tactile contact. More information on how the tools may make this determination is set forth elsewhere herein (e.g., see the description of FIG. 1).

The tools proceed to block 208 if the state has changed (along the “Yes” path) or to block 210 if the state has not changed (along the “No” path).

Block 208 switches the input mode from a previous input mode to a current input mode when there is a state change, such as when the number of tactile contacts represented in the contact data changes. For example, the tools may switch input modes from a multi-input mode (e.g., two contacts, such as two fingers or two stylus or some combination thereof) to a single-input mode (e.g., a single contact, such as a touch of a finger or stylus) in response to the contact data including a single tactile contact instead of multiple tactile contacts.

Block 210 maintains the current input mode when no state change is determined.

Block 212 identifies gestures in accordance with the current input mode. For example, if the tools are in multi-input mode, the tools may identify that a user made a pinching gesture based on two tactile contacts. The tools may heuristically identify the gestures based on previous tactile contacts. In other instances, the tools identify gestures within a predetermined range or tolerance. In single-input mode, the tools may ignore or disregard contact data associated with a second tactile contact. In this way, the tools ignore inadvertent tactile contacts.

Block 214 initiates a function that is mapped to the identified gestures. In some cases the tools may additionally initiate an auxiliary function as well. For instance, in addition to providing a zoom function, the tools initiate an application to display a toolbar that is related to the zooming function. In this manner, while the tools initiate the zoom in or zoom out function, a user can adjust the toolbar to control the zoom function.

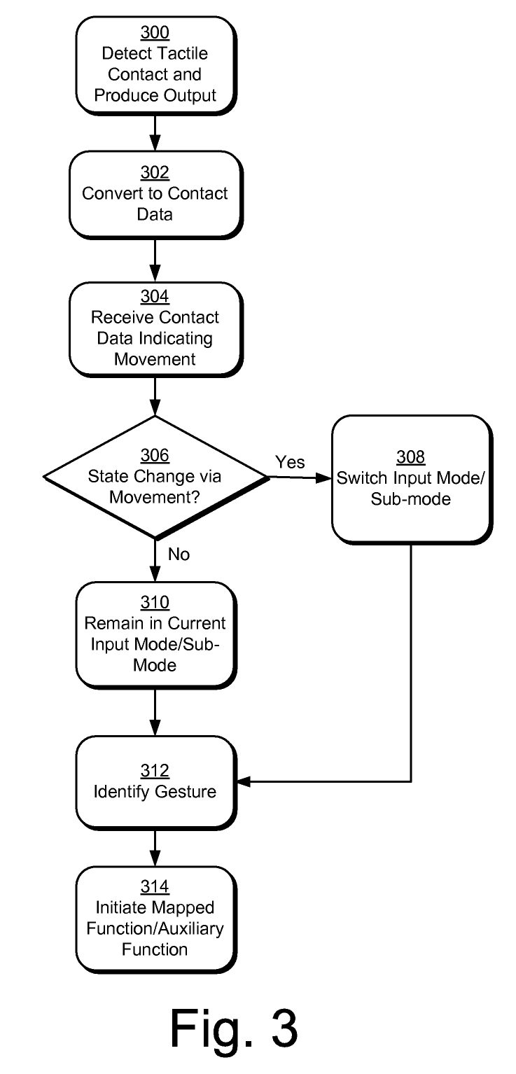

FIG. 3 depicts a procedure in an example implementation in which the tools initiate a mapped function. The tools switch input modes and/or sub-modes based on tactile contact movement.

Block 300 detects tactile contacts and generates output that represents the detected tactile contact. The tools generate an output that represents the user's physical interaction (e.g., tactile contact) with a contact detection device (e.g., a touch pad or touch screen).

Block 302 converts the output into contact data. For example, the contact data indicates characteristics of the tactile contact, such as whether a tactile contact is moving, the number of tactile contacts, how long tactile contact has been detected, and the like.

Block 304 receives contact data indicating movement of a tactile contact from the contact data. The tools determine whether a tactile contact is moving by determining whether an adjacent contact detector has generated an output. By using movement as a basis for switching input modes, the tools do not initiate certain functions that are or are not associated with movement. For instance, the tools forgo initiating functions mapped to non-moving tactile contacts when the input mode is associated with movement.

Alternatively or additionally, the tools may also receive and base determinations on other types of contact data, such tactile contact duration (e.g., time), orientation, contact pressure, and the like. For example, when the tools watch for tactile contact duration, the tools can change state if a tactile contact remains fixed for a set period time.

Block 306 determines if a state change has occurred. If it has, the tools proceed to block 308 along the “Yes” path. If the state has not changed, the tools proceed along the “No” path to block 310.

The tools determine that a change of state has occurred in response to a change in the received contact data, such as when the contact data indicates that a tactile contact begins to move. Using tactile contact movement as a basis for switching input modes may permit efficient identification and limit the number of gestures that are available for identification.

Using movement as a criterion for switching input modes and/or sub-modes permits a user to signal his/her intention to initiate another function by commencing movement or stopping the tactile contact. Thus, a user can signal his/her intention to switch sub-modes by momentarily halting a tactile contact.

Block 308 switches the tools' mode or sub-mode based on whether a moving tactile contact is represented in the contact data. For instance, the tools change sub-modes from a stationary mode to moving mode when two tactile contacts start moving. In other embodiments, the tools switch sub-modes from a moving sub-mode to a stationary sub-mode when two tactile contacts stop moving. The tools may also switch to a hybrid sub-mode when at least one tactile contact is moving and at least one tactile contact is static.

Block 310 maintains the current mode and sub-mode when no change in motion occurs (e.g., whether the tactile contacts are moving or not).

Block 312 identifies the gestures based on the tools' input mode/sub-mode. For example, when the tools are in single-input mode, the tools may only identify a single moving tactile contact from the contact data. In another example, the tools do not identify multiple moving tactile contacts when in single-input mode.

Block 314 initiates a function that is mapped to the identified gestures. In one or more embodiments, the tools additionally may initiate an auxiliary function (e.g., any of those auxiliary functions mentions above).

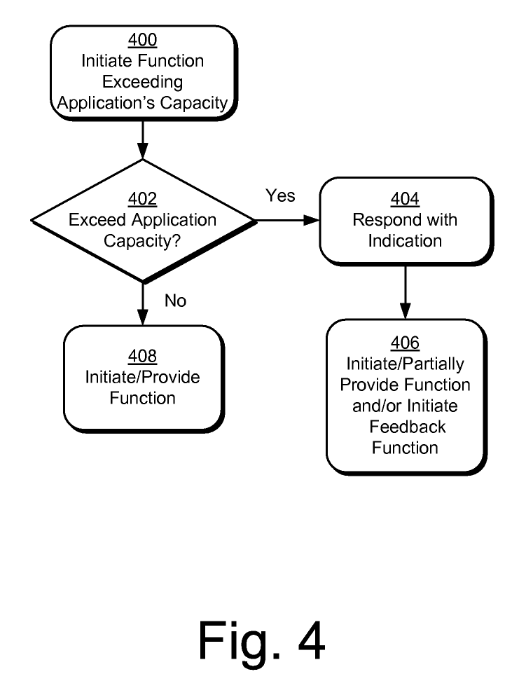

FIG. 4 depicts a procedure in an example implementation in which the tools initiate a feedback function to indicate that a function, if performed, would exceed an application's capacity, as well as other actions.

Block 400 receives an indication of an initiated function or initiates a function that may exceed the capacity of an application to which the function is directed. For example, the multi-input system 102 may initiate a pan function that will exceed the capacity of a web browsing application by panning beyond the border of a web page.

Block 402 determines whether the initiated function will exceed the application's capacity. For example, the tools, in conjunction with or in communication with a web browsing application may determine that the extent of the function directed at the application, if performed, would exceed the application's capacity to pan by going over the border of the web page. If block 402 determines that the initiated function will exceed the application's capacity, it proceeds to block 404. If the function will not exceed the application's capacity, the tools proceed to block 408.

Block 404 signals that the function cannot be performed or only a portion of the function can be performed. For example, the application may signal the tools that the application cannot perform the entire function. In such instances, the tools may break the function into portions, a portion that can be performed and a portion that cannot. In such a case the application may receive the portion that can be performed and perform this portion, such as by panning to the border of the web page but not beyond it. In either case, the tools proceed to block 406 if all or any of the function cannot be performed.

Block 406 initiates a feedback function. The tools initiate a feedback function that alerts the user of the condition. For example, the tools may initiate a feedback function that causes a display to dither, distorts the document, or shakes (via zooming in and out or panning in and out). In this way, a user is alerted that the operation has reached a boundary of the application or that only a portion of the function is being performed.

Block 408 provides the function if the function is within the capability of the application.

Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable media having computer-executable instructions that, when executed by a computing device, perform acts comprising:
determining, based on contact data representing one or more tactile contacts, that a change in state has occurred in the one or more tactile contacts; and
switching an input mode from a single-input mode to a multi-input mode or from the multi-input mode to the single-input mode responsive to determining that the change in state has occurred.

2. The media of claim 1, wherein the act of switching the input mode switches to the multi-input mode and further comprising:
receiving contact data associated with a first tactile contact and a second tactile contact of said one or more tactile contacts;
determining, based on the contact data, a gesture in accordance with the multi-input mode and associated with the first tactile contact and the second tactile contact; and
initiating a function mapped to the gesture.

3. The media of claim 2, wherein the gesture comprises a pinching gesture, a modified pinching gesture, a spreading gesture, a modified spreading gesture, a double slide gesture, a two-finger tap gesture, a sequential tap gesture, a two-finger press-and-hold gesture, a diagonal double slide gesture, a two-finger rotate, or a four-finger tap gesture.

4. The media of claim 3, wherein the function mapped with the gesture comprises a zoom out, another zoom out, a zoom in, another zoom in, a pan, a double click, a right click, a route find, a rotate view, a flip in three dimensions, or a launch application respectively.

5. The media of claim 1, wherein the act of switching the input mode switches to the single-input mode and further comprising:
receiving contact data associated with a first tactile contact and a second tactile contact; and
ignoring or disregarding either the first tactile contact or the second tactile contact.

6. The media of claim 1, wherein the one or more tactile contacts are received through contact detectors of a contact detection device comprising a touch pad or touch screen capable of detecting two or more tactile contacts, and the two or more tactile contacts comprise two or more fingertips.

7. The media of claim 1, wherein the contact data includes information indicating a new tactile contact to a contact detection device or cessation of an existing tactile contact to the contact detection device and the act of determining is based on the information.

8. The media of claim 7, wherein the contact data further comprises additional information, the additional information indicating a duration, movement, orientation, pressure, contact vector, or movement of the new tactile contact or the existing tactile contact and the act of determining is based on the additional information.

9. A method comprising:
determining, based on contact data representing movement of one or more tactile contacts, that a change in state has occurred in the tactile contacts; and
switching from a multi-input movement sub-mode, a multi-input hybrid sub-mode, or a multi-input static sub-mode to another of the multi-input movement sub-mode, the multi-input hybrid sub-mode, or the multi-input static sub-mode responsive to determining that the change in state has occurred.

10. The method of claim 9, wherein the act of switching comprises switching from the multi-input static sub-mode or multi-input hybrid mode to the multi-input movement sub-mode.

11. The method of claim 10, further comprising:
receiving the contact data, the contact data associated with movement of a first tactile contact and movement of a second tactile contact of said one or more tactile contacts;
determining, based on both the movement of the first tactile contact and the movement of the second tactile contact, a gesture in accordance with the multi-input movement sub-mode and associated with the movement of the first tactile contact and the movement of the second tactile contact; and
initiating a function mapped to the gesture.

12. The method of claim 11, wherein the gesture comprises a pinching gesture, a double slide gesture, or an opposite slide gesture.

13. The method of claim 12, wherein the function mapped with the gesture comprises a zoom, pan, or flip in three dimensions, respectively.

14. The method of claim 9, wherein the act of switching comprises switching from the multi-input static sub-mode or multi-input movement mode to the multi-input hybrid sub-mode and further comprising initiating a function mapped to a gesture associated with movement of a first tactile contact and static contact of a second tactile contact.

15. The method of claim 9, wherein the act of switching comprises switching from the multi-input movement sub-mode or the multi-input hybrid sub-mode to the multi-input static sub-mode and further comprising:
receiving the contact data, the contact data associated with movement of a tactile contact of the one or more tactile contacts; and
ignoring or disregarding the movement of the tactile contact.

16. The method of claim 9, wherein the contact data further comprises information indicating a duration of physical contact with a contact detection device of the one or more tactile contacts and the act of determining is based on the information.

17. A method comprising:
initiating a function for an application, the function based on one or more tactile contacts received through a contact detection device;
determining that said initiated function exceeds a capacity of the application to fully perform the initiated function; and
initiating a feedback function for the application, the feedback function indicating that the initiated function exceeds the capacity of the application to fully perform the initiated function.

18. The method of claim 17, further comprising:
determining a portion of the initiated function that does not exceed the capacity of the application; and
initiating the portion of the initiated function that does not exceed the capacity of the application effective to enable the application to perform the portion prior to performing the feedback function.

19. The method of claim 17, wherein the one or more tactile contacts indicate a pinching gesture, spreading gesture, or a double slide gesture, if the pinching gesture the initiated function comprising a zoom-out function, if the spreading gesture the initiated function comprising a zoom-in function, or if the double slide gesture the initiated function comprising a pan function.

20. The method of claim 19, wherein if the pinching gesture or the spreading gesture, the feedback function comprises a shaking zoom function rapidly zooming in and out, or if the double slide gesture the feedback function comprising a shaking pan function rapidly panning in opposite directions or a window or frame alteration, the window or the frame surrounding a display panned by the pan function.
